(19) United States
(12) Patent Application Publication
(10) Pub. No.: US 2020/0295681 A1
(43) Pub. Date: Sep. 17, 2020

(54) Voltage Boosting Fan Motor Control

(71) Applicant: DENSO International America, Inc., Southfield, MI (US)

(72) Inventors: Brett THOMAS, Flint, MI (US); Yusuke MASUMOTO, Novi, MI (US)

(21) Appl. No.: 16/298,416

(22) Filed: Mar. 11, 2019

(51) Int. Cl. H02P 7/29; G06F 1/26; G06F 1/20; H02P 6/08; F04D 27/00; F01P 7/02; B60K 11/06

(52) U.S. Cl. CPC H02P 7/29; G06F 1/26; G06F 1/206; B60K 11/06; F04D 27/004; F01P 7/02; H02P 6/08

(57) ABSTRACT

Systems and methods are provided and include an engine temperature sensor, an engine speed sensor, a switching arrangement, a radiator fan control module, and a pulse-width modulation module. The radiator fan control module calculates a required airflow of a radiator fan of the vehicle based on an engine temperature and calculates a required voltage to produce the required airflow of the radiator fan based on a size of the radiator fan. The radiator fan control module generates a control signal to increase a fan motor voltage of a radiator fan motor in response to the required voltage exceeding a battery voltage and generates the control signal to maintain a standard fan motor voltage of the radiator fan motor in response to the required voltage being less than the battery voltage. The pulse-width modulation module controls a switching operation of the at least one switch in accordance with the control signal.

### FIELD

The present disclosure relates to fans in a vehicle, more specifically to engine cooling using fans in the vehicle.

### BACKGROUND

To prevent an engine within a vehicle from overheating, a radiator fan is included within the vehicle to dissipate heat. The radiator fan blows air onto the engine to cool the engine. There are a variety of radiator fans for each vehicle size and type. The radiator fans may vary by blade size, blade numbers, blade angles, etc. Each radiator fan variable alters the cooling effect of the radiator fan, making the radiator fan more or less efficient depending on its design.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A system is provided and includes a temperature sensor configured to determine a temperature of an engine of a vehicle, an engine speed sensor configured to determine a vehicle speed, a switching arrangement including at least one switch, and a radiator fan control module configured to calculate a required airflow of a radiator fan of the vehicle based on the temperature, calculate a required voltage to produce the required airflow of the radiator fan based on a size of the radiator fan, in response to the required voltage exceeding a battery voltage, generate a control signal to increase a fan motor voltage of a motor of the radiator fan, and in response to the required voltage being less than the battery voltage, generate the control signal to maintain a standard fan motor voltage of the motor of the radiator fan. The system also includes a pulse-width modulation (PWM) module configured to control switching operation of the at least one switch in accordance with the control signal.

In other features, the radiator fan control module is further configured to: in response to the temperature exceeding a temperature threshold, generate the control signal to increase the fan motor voltage of the motor of the radiator fan; in response to the vehicle speed exceeding a maximum speed threshold, generate the control signal to increase the fan motor voltage of the motor of the radiator fan; and in response to the vehicle speed being lower than a minimum speed threshold, generate the control signal to maintain the standard fan motor voltage of the motor of the radiator fan.

In other features, the temperature sensor is configured to measure an engine coolant temperature.

In other features, the system includes an engine control module, wherein the engine control module receives a temperature signal from the temperature sensor indicating the temperature.

In other features, the engine control module receives an engine speed signal from the engine speed sensor indicating the vehicle speed.

In other features, the engine control module includes a lookup table, and wherein the lookup table includes: (i) the temperature threshold, (ii) the maximum speed threshold, (iii) the minimum speed threshold, and (iv) the size of the radiator fan.

In other features, the at least one switch is an n-channel metal-oxide-semiconductor field-effect transistor (MOSFET).

In other features, the control signal to maintain the standard fan motor voltage directs a voltage booster circuit to apply the battery voltage to the motor.

In other features, the control signal to increase the fan motor voltage of the motor of the radiator fan instructs the PWM module to increase a duty cycle.

In other features, the voltage booster circuit is coupled between the motor of the radiator fan and a battery of the vehicle.

A method is also provided and includes determining, with a temperature sensor, a temperature of an engine of a vehicle, determining, with an engine speed sensor, a vehicle speed of the vehicle, calculating, with a radiator fan control module, a required airflow of a radiator fan of the vehicle based on the temperature, calculating, with the radiator fan control module, a required voltage to produce the required airflow of the radiator fan based on a size of the radiator fan, in response to the required voltage exceeding a battery voltage, generating, with the radiator fan control module, a control signal to increase a fan motor voltage of a motor of the radiator fan, in response to the required voltage being less than the battery voltage, generating, with the radiator fan control module, the control signal to maintain a standard fan motor voltage of the motor of the radiator fan, and controlling, with a pulse-width modulation (PWM) module, a switching operation of at least one switch in accordance with the control signal.

In other features, the method further includes in response to the temperature exceeding a temperature threshold, generating, with the radiator fan control module, the control signal to increase the fan motor voltage of the motor of the radiator fan, in response to the vehicle speed exceeding a maximum speed threshold, generating, with the radiator fan control module, the control signal to increase the fan motor voltage of the motor of the radiator fan, and in response to the vehicle speed being lower than a minimum speed threshold, generating, with the radiator fan control module, the control signal to maintain the standard fan motor voltage of the motor of the radiator fan.

In other features, the temperature sensor is configured to measure an engine coolant temperature.

In other features, the method further includes receiving, with an engine control module, a temperature signal from the temperature sensor indicating the temperature.

In other features, the method further includes receiving, with the engine control module, an engine speed signal from the engine speed sensor indicating the vehicle speed.

In other features, the engine control module includes a lookup table, and wherein the lookup table includes: (i) the temperature threshold, (ii) the maximum speed threshold, (iii) the minimum speed threshold, and (iv) the size of the radiator fan.

In other features, the at least one switch is an n-channel metal-oxide-semiconductor field-effect transistor (MOSFET).

In other features, the control signal to maintain the standard fan motor voltage directs a voltage booster circuit to apply the battery voltage to the motor.

In other features, the control signal to increase the fan motor voltage of the motor of the radiator fan instructs the PWM module to increase a duty cycle.

In other features, the voltage booster circuit is coupled between the motor of the radiator fan and a battery of the vehicle.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a functional block diagram of a radiator fan control module integrated within a vehicle;

FIG. 2 is a schematic of a voltage booster within a vehicle;

FIG. 3 is a flowchart depicting a radiator fan control module function;

FIG. 4 is a graph depicting a difference in airflow volume for different vehicle speeds;

FIG. 5 is a graph depicting changes in airflow volume and torque for different vehicle speeds and vehicle loads; and

FIG. 6 is a graph depicting the voltage requirements for different original equipment manufacturers (OEMs) in standard radiator fan control.

In the drawings, reference numbers may be reused to identify similar and/or identical elements.

### DETAILED DESCRIPTION

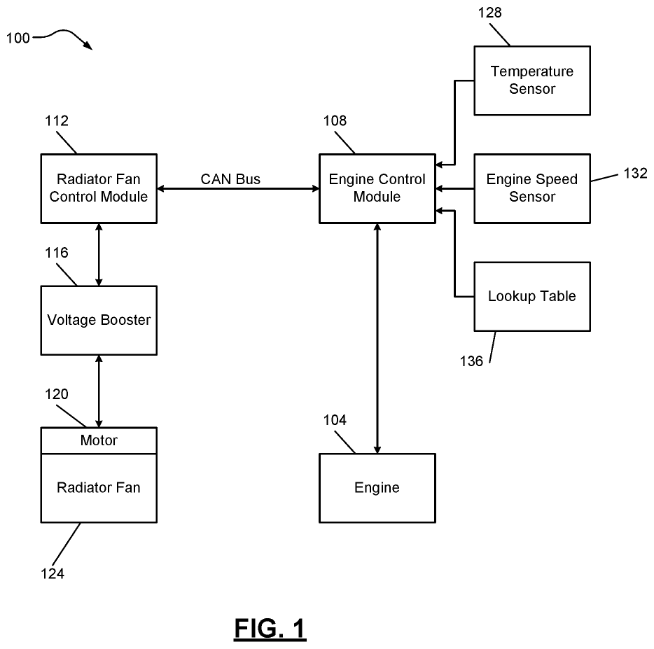

Referring to FIG. 1, a functional block diagram of a radiator fan control module integrated within a vehicle 100 is shown. The vehicle 100 includes an engine 104, an engine control module (ECM) 108, a radiator fan control module 112, a voltage booster 116, a motor 120, a radiator fan 124, a temperature sensor 128, an engine speed sensor 132, and a lookup table 136. The engine 104 is controlled by the ECM 108. The engine 104 communicates with sensors throughout the vehicle 100, e.g., the temperature sensor 128 and the engine speed sensor 132. The temperature sensor 128 measures the engine coolant temperature within the vehicle 100. Alternatively, the temperature sensor 128 may measure the temperature in another area of the vehicle 100 that represents the temperature of the engine 104. The engine speed sensor 132 is attached to a crankshaft (not shown) of the engine 104. A vehicle speed can be calculated based on the engine speed. The engine 104 may communicate with additional sensors such as a throttle position sensor (TPS), an oxygen sensor, an air to fuel ratio (AFR) sensor, a manifold absolute pressure (MAP) sensor, an accelerator position sensor, and a mass airflow (MAF) sensor.

The radiator fan 124 is controlled by the radiator fan control module 112. The ECM 108 communicates sensor information to the radiator fan control module 112, such as through a controller area network (CAN) bus. The radiator fan control module 112 can control the motor 120 of the radiator fan 124 using the voltage booster 116. The radiator fan control module 112 can adjust the radiator fan speed to increase an airflow volume by increasing the voltage (or boosting the voltage) delivered to the motor 120. Alternatively, the radiator fan control module 112 can adjust the radiator fan speed to decrease airflow volume by not increasing the voltage delivered to the motor 120.

By increasing the voltage delivered to the motor, the radiator fan 124 can produce a larger airflow volume, independent of its size, using a smaller input voltage. In this way, the radiator fan 124 is not limited by its size. That is, the voltage booster 116 assists smaller radiator fans produce larger airflow volumes. Further, instead of requiring different radiator fan designs for different vehicles, each vehicle can use the same radiator fan design with a fan control that increases the airflow volume produced by the radiator fan when necessary by increasing the voltage delivered to the motor 120.

The radiator fan control module 112 can determine whether the voltage provided to the motor 120 should be increased in response to the engine coolant temperature exceeding a temperature threshold. The engine coolant temperature is determined from the temperature sensor 128. The ECM 108 receives a signal from the temperature sensor 128 corresponding to the engine coolant temperature. The engine coolant temperature is communicated to the radiator fan control module 112 through the CAN bus and used to determine whether the voltage delivered to the motor 120 should be increased. In some implementations, when the voltage has been increased, the radiator fan control module 112 may also determine when to decrease the voltage delivered to the motor 120. That is, in response to the engine coolant temperature falling below a minimum threshold, the radiator fan control module 112 can direct the voltage booster 116 to no longer increase the voltage supplied to the motor 120.

The radiator fan control module 112 can calculate a required airflow volume of the radiator fan 124. For example, the amount of heat transferred (H) can be calculated by multiplying the specific heat of the air (Cₚ) by the change in temperature (ΔT) by the mass heat transfer or airflow (W):

H=Cₚ×W×ΔT. (Equation 1)

Further, the mass heat transfer can be calculated by multiplying the amount of airflow needed to removed heat or required airflow volume (CFM) by the density (D):

W=CFM×D. (Equation 2)

From the above equations, the required airflow volume (CFM) can be calculated by using the following equation:

$$C F M = \frac{H}{{C}_{p} \times D \times Δ T} . \qquad ( Equation 3 )$$

Using equation 3, the radiator fan control module 112 can determine the required airflow volume to remove the heat when the temperature or the change in temperature exceeds a maximum threshold. In response to the temperature or the change in temperature (as determined by the temperature sensor 128) exceeding the maximum threshold, the radiator fan control module 112 can increase the voltage delivered to the motor 120 for a predetermined time. Alternatively, the radiator fan control module 112 can increase the voltage delivered to the motor 120 until the temperature falls below a minimum threshold. That is, the voltage delivered to the motor 120 can decrease once the temperature sensor 128 determines that the engine coolant temperature is below the minimum threshold.

In other implementations, the radiator fan control module 112 can determine whether the voltage delivered to the motor 120 should be increased in response to the vehicle speed exceeding a predetermined speed. When the vehicle speed exceeds the predetermined speed, the engine 104 may need additional cooling. When the radiator fan control module 112 increases the voltage delivered to the motor 120, the airflow volume increases, which cools down the engine 104.

For example, the predetermined speed may be a static threshold value for all radiator fans and vehicles. Alternatively, the radiator fan control module 112 may reference the lookup table 136, which can include different thresholds based on the size of the radiator fan 124, the type of vehicle, and the size of the vehicle.

The size of the radiator fan 124 as well as the kind of vehicle 100 affects the required airflow volume of the radiator fan 124. For example, when the radiator fan 124 is smaller in size, the airflow volume provided at a first voltage is less than the airflow volume provided by a larger fan. To determine additional airflow requirements, the radiator fan control module 112 can account for the size of the radiator fan 124 when determining whether to direct the voltage booster 116 to increase the voltage of the motor 120. Additionally, larger vehicles can require increased heat dissipation. Therefore, the radiator fan control module 112 can further account for the type of vehicle when determining whether to deliver an increased voltage to the motor 120.

The radiator fan control module 112 can adjust the voltage delivered to the motor 120 according to the size of the radiator fan 124 and the type of vehicle100. That is, independent of vehicle type, size, or radiator fan size, a radiator fan design may be standardized across vehicles and manufacturers using the increased voltage when necessary. Additionally, smaller radiator fan designs may be used to meet higher heat dissipation demands without needing to adjust fan blade size, the number of fan blades, or blade angle.

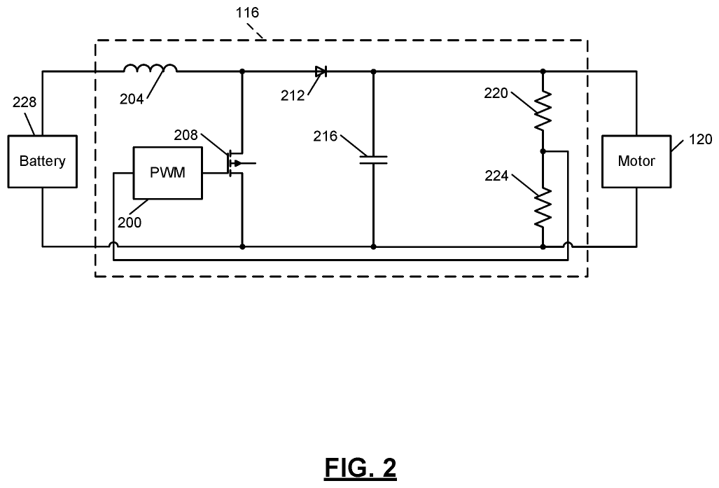

Referring to FIG. 2, a schematic of the voltage booster 116 within the vehicle is shown. In the present implementation, the voltage booster 116 includes a pulse-width modulation module (PWM) 200, an inductor 204, a transistor 208, a diode 212, a capacitor 216, a first resistor 220, and a second resistor 224. The voltage booster 116 receives an input voltage from a battery 228. The battery 228 may be a vehicle battery or a separate battery for the voltage booster 116. The PWM 200 controls switching cycles of the transistor 208. When the transistor 208 is on, the current flows through the transistor 208 causing the current to build up in the inductor 204. When the transistor 208 is off, the current flows through the diode 212 and the capacitor 216. The transistor 208 is switched on and off for multiple cycles, which builds up voltage in the capacitor 216. From the voltage build up, an increased voltage is delivered to the motor 120.

The PWM 200 has a duty cycle. The duty cycle determines how long the transistor 208 is switched on and how long the transistor 208 is switched off. The duty cycle controls the increase in the amount of voltage delivered to the motor 120. That is, as the duty cycle increases, the voltage delivered to the motor 120 increases as well. When the voltage delivered to the motor 120 is increased, the speed of the radiator fan 124 increases as well as the airflow volume produced by the radiator fan 124. When the voltage delivered to the motor 120 is not increased, the airflow volume and speed of the radiator fan 124 are not increased.

The radiator fan control module 112 can control the motor 120 by adjusting the duty cycle of the PWM 200. That is, when an increased airflow volume of the radiator fan 124 is required or desired, the radiator fan control module 112 can increase the duty cycle of the PWM 200 using a control signal. The radiator fan control module 112 can generate the control signal to increase the voltage delivered to the motor 120 or generate the control signal to maintain a standard fan motor voltage, i.e., the voltage of the battery 228.

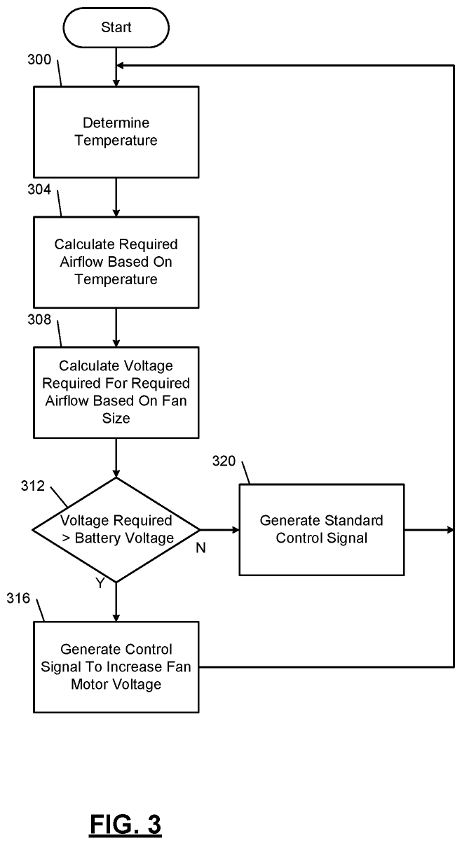

Referring to FIG. 3, a flowchart depicting the radiator fan control module function is shown. Control starts at 300 to determine the temperature within the engine 104. The temperature sensor 128 determines the engine coolant temperature and sends the temperature readings to the ECM 108. Alternatively, the temperature sensor 128 may be configured to measure a different temperature within the engine 104. The ECM 108 communicates the temperature to the radiator fan control module 112 via the CAN bus.

At 304, the radiator fan control module 112 calculates the required airflow volume based on the temperature using one of the methods above. For example, the radiator fan control module 112 may determine the required airflow volume using equation 3. At 308, the radiator fan control module 112 calculates the voltage required for the required airflow volume based on the size of the radiator fan 124.

That is, the radiator fan control module 112 calculates what amount of voltage is needed for the radiator fan 124 to produce the required airflow volume needed to cool the engine 104 (i.e., reduce any increase in temperature in the engine 104). The size of the radiator fan is used to determine the airflow volume produced at a given voltage.

At 312, the radiator fan control module 112 determines whether the voltage required is greater than the voltage of the battery 228. If yes, the radiator fan control module 112 generates a control signal to increase the fan motor voltage.

The radiator fan control module 112 will generate the control signal and send the control signal to the voltage booster 116 to increase the duty cycle of the PWM 200. In response, the voltage delivered to the motor 120 will increase, resulting in a faster rotating radiator fan 124 and faster cooling. While the increased voltage delivered to the motor 120 can create more heat, the additional heat will be dissipated due to the increased airflow volume of the radiator fan 124.

Instead, if the voltage required is less than or equal to the voltage of the battery 228 at 312, the radiator fan control module 112 generates a standard control signal at 320. The standard control signal directs the voltage booster 116 to not increase the voltage delivered to the motor 120. The standard control signal may do this by adjusting the duty cycle, as discussed above, resulting in the voltage of the battery 228 being delivered to the motor 120. After the control signal is generated at 316 or 320, control returns to 300 to monitor the temperature.

In other implementations, control may monitor the change in temperature. If the change in temperature exceeds a predetermined amount, the radiator fan control module 112 can generate the control signal to increase the voltage delivered to the motor 120.

In alternative implementations, control may monitor the speed of the vehicle 100. If the speed of the vehicle 100 exceeds a predetermined threshold, the radiator fan control module 112 can generate the control signal to increase the voltage delivered to the motor 120.

As mentioned above, in alternative implementations, the control signal to increase the voltage can be generated until a condition met (i.e., the required voltage is equal to or below the voltage of the battery 228, temperature falls below a threshold, etc.). Alternatively, the radiator fan control module 112 may increase the voltage delivered to the motor 120 for a predetermined period.

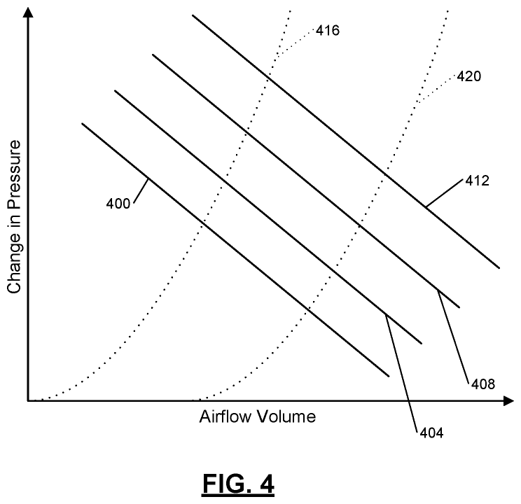

Referring to FIG. 4, a graph depicting a difference in airflow volume for different vehicle speeds is shown.

The graph depicts the airflow volume limitations of the battery 228 of the vehicle 100 based on the voltage of the battery 228. The lowest is a six volt battery, shown at 400. Next, an eight volt battery is shown at 404. A ten volt battery is shown at 408. The highest airflow volume is a twelve volt battery, shown at 412. When the vehicle speed is 0 mph at 416, the airflow volume needed increases for each increase in battery 228 voltage. Similarly, when the vehicle is traveling at 50 mph at 420, the airflow volume required is higher overall and increases for higher battery 228 voltages.

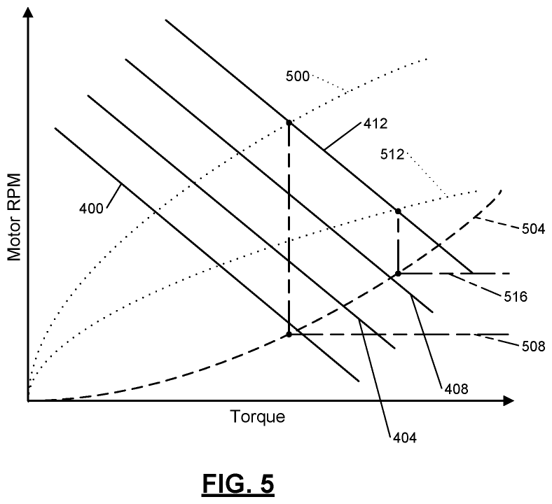

Referring to FIG. 5, a graph depicting changes in airflow volume and torque for different vehicle speeds and vehicle loads is shown. The varying motor voltages 400, 404, 408, and 412 are shown on a graph depicting motor revolutions per minute (RPM) versus torque. When the vehicle is traveling 50 mph at 500, the load is small, requiring less torque and less airflow volume 504 as shown on the graph at 508. When the vehicle is traveling at 0 mph at 512, the load is large, requiring more torque and more airflow volume 504 as shown on the graph at 516.

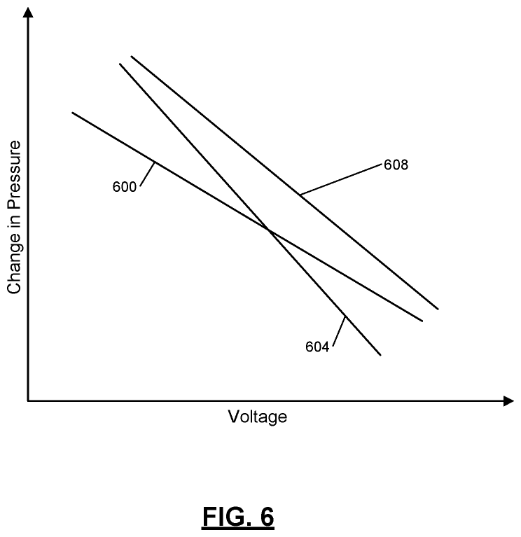

Referring to FIG. 6, a graph depicting the voltage requirements for different original equipment manufacturers (OEMs) in standard radiator fan control is shown.

The voltage of a radiator fan of OEM A can vary depending on multiple factors, including changes in pressure, vehicle speed, vehicle load, etc., as shown by line 600. Similarly, the radiator fan for OEM B can have varying voltage requirements as well as shown by 604. Therefore, the voltage of OEM B 604 cannot meet the high voltage requirements of OEM A 600. However, using the radiator fan control module 112 and voltage booster 116, the voltage requirement of both OEM A 600 and OEM B 604 can be met by increasing the voltage delivered to the motor 120 when necessary.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

1. A system comprising:
a temperature sensor configured to determine a temperature of an engine of a vehicle;
an engine speed sensor configured to determine a vehicle speed;
a switching arrangement including at least one switch;
a radiator fan control module configured to:
calculate a required airflow of a radiator fan of the vehicle based on the temperature;
calculate a required voltage to produce the required airflow of the radiator fan based on a size of the radiator fan;
in response to the required voltage exceeding a battery voltage, generate a control signal to increase a fan motor voltage of a motor of the radiator fan;
in response to the required voltage being less than the battery voltage, generate the control signal to maintain a standard fan motor voltage of the motor of the radiator fan;
in response to the vehicle speed exceeding a maximum speed threshold, generate the control signal to increase the fan motor voltage of the motor of the radiator fan; and
in response to the vehicle speed being lower than a minimum speed threshold, generate the control signal to maintain the standard fan motor voltage of the motor of the radiator fan;
a pulse-width modulation (PWM) module configured to control switching operation of the at least one switch in accordance with the control signal; and
a lookup table including: (i) the maximum speed threshold, (ii) the minimum speed threshold, and (iii) the size of the radiator fan.

2. The system of claim 1, wherein the radiator fan control module is further configured to:
in response to the temperature exceeding a temperature threshold, generate the control signal to increase the fan motor voltage of the motor of the radiator fan.

3. The system of claim 2 wherein the temperature sensor is configured to measure an engine coolant temperature.

4. The system of claim 2 further comprising an engine control module, wherein the engine control module receives a temperature signal from the temperature sensor indicating the temperature.

5. The system of claim 4 wherein the engine control module receives an engine speed signal from the engine speed sensor indicating the vehicle speed.

6. The system of claim 5 wherein the engine control module includes the lookup table, and wherein the lookup table includes the temperature threshold.

7. The system of claim 1, wherein the at least one switch is an n-channel metal-oxide-semiconductor field-effect transistor (MOSFET).

8. The system of claim 1 wherein the control signal to maintain the standard fan motor voltage directs a voltage booster circuit to apply the battery voltage to the motor.

9. The system of claim 8 wherein the control signal to increase the fan motor voltage of the motor of the radiator fan instructs the PWM module to increase a duty cycle.

10. The system of claim 9 wherein the voltage booster circuit is coupled between the motor of the radiator fan and a battery of the vehicle.

11. A method comprising:
determining, with a temperature sensor, a temperature of an engine of a vehicle;
determining, with an engine speed sensor, a vehicle speed of the vehicle;
calculating, with a radiator fan control module, a required airflow of a radiator fan of the vehicle based on the temperature;
calculating, with the radiator fan control module, a required voltage to produce the required airflow of the radiator fan based on a size of the radiator fan;
in response to the required voltage exceeding a battery voltage, generating, with the radiator fan control module, a control signal to increase a fan motor voltage of a motor of the radiator fan;
in response to the required voltage being less than the battery voltage, generating, with the radiator fan control module, the control signal to maintain a standard fan motor voltage of the motor of the radiator fan;
in response to the vehicle speed exceeding a maximum speed threshold, generating, with the radiator fan controi module, the control signal to increase the fan motor voltage of the motor of the radiator fan;
in response to the vehicle speed being lower than a minimum speed threshold, generating, with the radiator fan control module, the control signal to maintain the standard fan motor voltage of the motor of the radiator fan; and
controlling, with a pulse-width modulation (PWM) module, a switching operation of at least one switch in accordance with the control signal, wherein a lookup table includes: (i) the maximum speed threshold, (ii) the minimum speed threshold, and (iii) the size of the radiator fan.

12. The method of claim 11, further comprising:
in response to the temperature exceeding a temperature threshold, generating, with the radiator fan control module, the control signal to increase the fan motor voltage of the motor of the radiator fan.

13. The method of claim 12, wherein the temperature sensor is configured to measure an engine coolant temperature.

14. The method of claim 12, further comprising receiving, with an engine control module, a temperature signal from the temperature sensor indicating the temperature.

15. The method of claim 14, further comprising receiving, with the engine control module, an engine speed signal from the engine speed sensor indicating the vehicle speed.

16. The method of claim 15 wherein the engine control module includes the lookup table, and wherein the lookup table includes the temperature threshold.

17. The method of claim 11, wherein the at least one switch is an n-channel metal-oxide-semiconductor field-effect transistor (MOSFET).

18. The method of claim 11, wherein the control signal to maintain the standard fan motor voltage directs a voltage booster circuit to apply the battery voltage to the motor.

19. The method of claim 18 wherein the control signal to increase the fan motor voltage of the motor of the radiator fan instructs the PWM module to increase a duty cycle.

20. The method of claim 19 wherein the voltage booster circuit is coupled between the motor of the radiator fan and a battery of the vehicle.
